(19) United States
(12) Patent Application Publication
(10) Pub. No.: US 2020/0232401 A1
(43) Pub. Date: Jul. 23, 2020

(54) ACTUATOR

(71) Applicant: DENSO CORPORATION, Kariya-city (JP)

(72) Inventors: Masashi YAMAGUCHI, Kariya-city (JP); Tetsuji YAMANAKA, Kariya-city (JP); Kunio NAMBA, Kariya-city (JP); Naoaki KONO, Kariya-city (JP); Atsushi TANAKA, Kariya-city (JP)

(21) Appl. No.: 16/842,108

(22) Filed: Apr. 7, 2020

Related U.S. Application Data
(63) Continuation of application No. PCT/JP2018/038683, filed on Oct. 17, 2018.

(30) Foreign Application Priority Data
Oct. 20, 2017 (JP) 2017-203298

(51) Int. Cl. F02D 41/00; F02B 37/18; G01B 7/30; F16H 1/20; F16H 57/04

(52) U.S. Cl. CPC F02D 41/0007; F02B 37/186; F16H 2057/02034; F16H 1/20; F16H 57/0464; G01B 7/30

(57) ABSTRACT

An actuator drives a boost pressure control valve of a supercharger of an engine and includes an electric motor, an output shaft, a speed reducer, a rotational angle sensor and a housing. The speed reducer includes three pairs of metal gears and is configured to reduce a speed of rotation outputted from the electric motor and transmit the rotation to the output shaft. The rotational angle sensor includes a magnetic circuit device and a sensing device and senses a rotational angle of the output shaft. The housing receives the metal gears and the magnetic circuit device in a common space and supports the output shaft. In an installed state of the actuator where the actuator is installed to the engine, a meshing portion of the metal gears is located on a lower side of a magnetic circuit lowest point in the gravity direction.

### CROSS REFERENCE TO RELATED APPLICATIONS

This application is a continuation application of International Patent Application No. PCT/JP2018/038683 filed on Oct. 17, 2018, which designated the U.S. and claims the benefit of priority from Japanese Patent Application No. 2017-203298 filed on Oct. 20, 2017. The entire disclosures of all of the above applications are incorporated herein by reference.

### TECHNICAL FIELD

The present disclosure relates to an actuator that drives a boost pressure control valve of a supercharger.

### BACKGROUND

Previously, there is known an actuator that is connected to the boost pressure control valve through, for example, a linkage mechanism and controls a boost pressure by adjusting a valve opening degree of the boost pressure control valve.

### SUMMARY

This section provides a general summary of the disclosure, and is not a comprehensive disclosure of its full scope or all of its features.

According to the present disclosure, there is provided an actuator configured to drive a boost pressure control valve of a supercharger of an internal combustion engine. The actuator includes an electric motor, an output shaft, a speed reducer, a rotational angle sensor and a housing. The speed reducer includes at least one pair of metal gears, which are meshed with each other. The speed reducer is configured to reduce a speed of rotation outputted from the electric motor and transmit the rotation of the reduced speed to the output shaft. The rotational angle sensor includes a magnetic circuit device and a sensing device and is configured to sense a rotational angle of the output shaft. The housing receives the electric motor and the speed reducer and supports the output shaft.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic diagram showing an intake and exhaust system of an internal combustion engine, at which an actuator according to a first embodiment is applied.

FIG. 2 is a side view of the engine.

FIG. 3 is a view of a supercharger taken in a direction of an arrow III in FIG. 2.

FIG. 4 is a perspective view of the actuator.

FIG. 5 is a top view of the actuator.

FIG. 6 is a cross-sectional view taken along line VI-VI in FIG. 5.

FIG. 7 is a cross-sectional view taken along line VII-VII in FIG. 5.

FIG. 8 is a diagram showing a state where a second housing segment of the actuator of FIG. 5 is removed.

FIG. 9 is a diagram corresponding to FIG. 8 while a large diameter gear of each of intermediate gears is partially cut and showing a state where an output shaft is rotated to one end of an operable range of the output shaft.

FIG. 10 is a diagram corresponding to FIG. 8 while the large diameter gear of each of the intermediate gears is partially cut and showing another state where the output shaft is rotated to the other end of the operable range of the output shaft.

FIG. 11 is a view of the actuator taken in a direction of an arrow XI in FIG. 5 while the housing is partially cut.

FIG. 12 is a side view of an internal combustion engine, to which an actuator of a second embodiment is applied.

FIG. 13 is a view of one of superchargers taken in a direction of an arrow XIII in FIG. 12.

FIG. 14 is a cross-sectional view of an actuator according to a third embodiment.

### DETAILED DESCRIPTION

Previously, there is known an actuator that is connected to a boost pressure control valve through, for example, a linkage mechanism and controls a boost pressure by adjusting a valve opening degree of the boost pressure control valve. One such actuator reduces a speed of rotation outputted from an electric motor through a speed reducer and thereafter outputs the rotation through an output shaft. Gears of the speed reducer are made of resin. A rotational angle of the output shaft is sensed with a contactless rotational angle sensor that includes a magnetic circuit device and a sensing device.

When the actuator is applied to an engine, which has a large exhaust gas pulsation, or a supercharger, which has a large wastegate port diameter, an excess stress is exerted to teeth of the gears of the speed reducer. In this case, the teeth of the gears made of the resin may possibly be damaged.

In view of the above point, the inventors of the present disclosure have been considering making the gears from metal. However, in this case, wear particles generated from the gears become a problem. If the wear particles generated from the gears adhere to the magnetic circuit device of the rotational angle sensor, the rotational angle sensing accuracy of the rotational angle sensor may possibly be deteriorated due to, for example, a magnetic short circuit of the magnetic circuit.

An actuator of the present disclosure includes an electric motor, an output shaft, a speed reducer, a rotational angle sensor and a housing. The speed reducer includes at least one pair of metal gears, which are meshed with each other. The speed reducer is configured to reduce a speed of rotation outputted from the electric motor and transmit the rotation of the reduced speed to the output shaft. The rotational angle sensor includes a magnetic circuit device and a sensing device and senses a rotational angle of the output shaft. The housing receives the electric motor and the speed reducer and supports the output shaft.

The housing receives the at least one pair of metal gears and the magnetic circuit device in a common space. In an installed state of the actuator where the actuator is installed to the internal combustion engine, a lowest point of the magnetic circuit device, which is lowest in a gravity direction within an operable range of the output shaft, is defined as a magnetic circuit lowest point. A meshing portion of the at least one pair of metal gears is located on a lower side of the magnetic circuit lowest point in the gravity direction.

By using the metal gears in the speed reducer, the required strength of the speed reducer against the relatively large load caused by the pulsation of the exhaust gas can be guaranteed. In this way, the damage to the gears of the speed reducer is limited. Furthermore, since the meshing portion of the metal gears is located on the lower side of the magnetic circuit lowest point in the gravity direction, the wear particles, which are generated at the metal gears, fall downward by the gravity in a direction away from the magnetic circuit device. In a case where the metal gears are made of a magnetic material, the wear particles are magnetic. Furthermore, even in a case where the material of the metal gears is not the magnetic material, if the gears are made of, for example, austenitic stainless steel or the like, the non-magnetized material may be magnetized due to application of strain to the non-magnetized material. In such a case, the wear particles of these gears become magnetic. Because of the above-described positional relationship between the meshing portion of the metal gears and the magnetic circuit lowest point, adhesion of the magnetic wear particles to the magnetic circuit at the time of falling down of the magnetic wear particles is limited. Therefore, it is possible to limit the deterioration in the rotational angle sensing accuracy caused by the adhesion of the wear particles to the magnetic circuit device.

Now, embodiments of the present disclosure will be described with reference to the accompanying drawings. In the following embodiments, similar portions, which are substantially identical to each other among the embodiments, will be indicated by the same reference signs and will not be described redundantly.

### First Embodiment

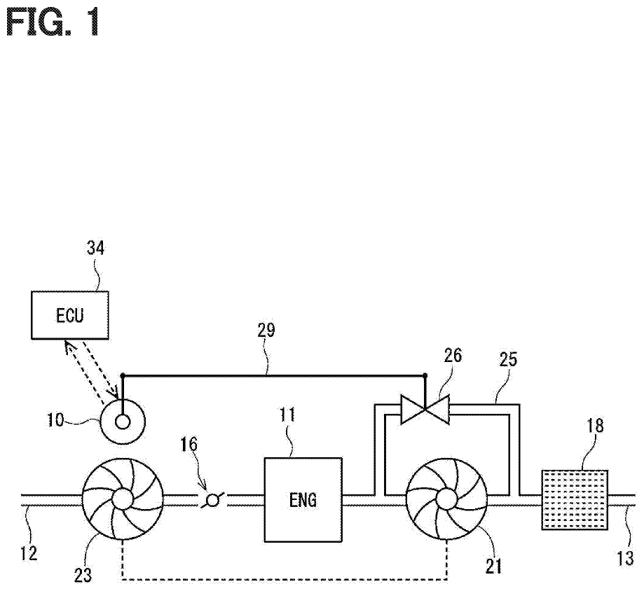

As shown in FIG. 1, an actuator 10 of a first embodiment is applied to an internal combustion engine 11 that is a drive source for driving a vehicle.

### (Intake and Exhaust System of Engine)

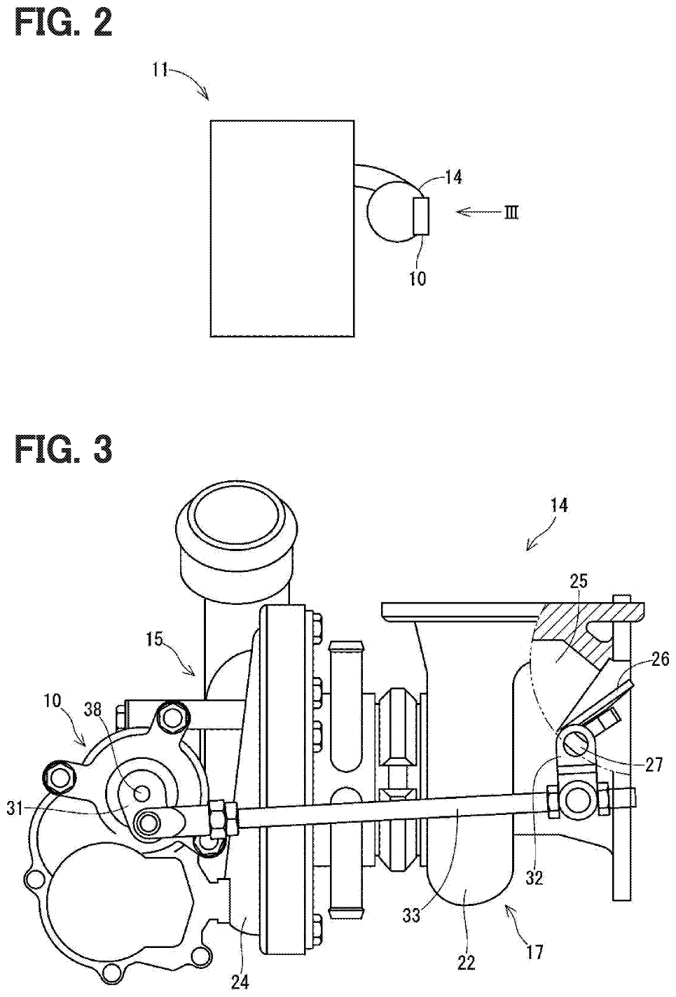

First of all, an intake and exhaust system of the engine 11 will be described with reference to FIGS. 1 to 3. The engine 11 has an intake passage 12, which conducts intake air to cylinders of the engine 11, and an exhaust passage 13, which discharges an exhaust gas generated at the cylinders to the atmosphere. An intake compressor 15 of a supercharger 14 and a throttle valve 16 are installed in the intake passage 12. The throttle valve 16 adjusts the amount of intake air supplied to the engine 11. An exhaust turbine 17 of the supercharger 14 and a catalyst 18 are installed in the exhaust passage 13. The catalyst 18 purifies the exhaust gas. The catalyst 18 is a known three-way catalyst, which has a monolithic structure. When the temperature of the catalyst 18 is raised to an activation temperature by the exhaust gas, the catalyst 18 purifies harmful substances contained in the exhaust gas through oxidation and reduction. The engine 11 is an in-line engine, and the supercharger 14 is mounted on one of the engine blocks.

The exhaust turbine 17 includes a turbine wheel 21, which is rotated by the exhaust gas outputted from the engine 11, and a turbine housing 22, which is shaped in a spiral form and receives the turbine wheel 21. The intake compressor 15 includes a compressor wheel 23, which is rotated by a rotational force of the turbine wheel 21, and a compressor housing 24, which is shaped in a spiral form and receives the compressor wheel 23.

A bypass passage 25 is formed at the turbine housing 22. The bypass passage 25 conducts the exhaust gas while bypassing the turbine wheel 21. The bypass passage 25 directly conducts the exhaust gas, which enters the turbine housing 22, to an exhaust gas outlet of the turbine housing 22. The bypass passage 25 can be opened and closed by a wastegate valve 26. The wastegate valve 26 is a swing valve that is rotatably supported by a valve shaft 27 at the inside of the turbine housing 22.

The supercharger 14 includes the actuator 10 as a drive means for driving the wastegate valve 26. The actuator 10 is installed to the intake compressor 15 that is spaced away from the exhaust turbine 17 to avoid influences of the heat of the exhaust gas. The supercharger 14 includes a linkage mechanism 29 that transmits the output of the actuator 10 to the wastegate valve 26. The linkage mechanism 29 is a so-called four-bar linkage. The linkage mechanism 29 includes: an actuator lever 31, which is rotated by the actuator 10; a valve lever 32, which is coupled to the valve shaft 27; and a rod 33, which transmits a rotational torque from the actuator lever 31 to the valve lever 32.

The operation of the actuator 10 is controlled by an ECU (Engine Control Unit) 34 that has a microcomputer. Specifically, the ECU 34 controls a boost pressure of the supercharger 14 by adjusting an opening degree of the wastegate valve 26 at, for example, a high rotational speed of the engine 11. Furthermore, when the temperature of the catalyst 18 does not reach the activation temperature thereof at, for example, the time immediately after cold start of the engine 11, the ECU 34 fully opens the wastegate valve 26 to warm up the catalyst 18 with the exhaust gas. In this way, the high temperature exhaust gas, which has not lost its heat to the turbine wheel 21, can be conducted to the catalyst 18, so that the catalyst 18 can be warmed up within a short period of time.

### (Actuator)

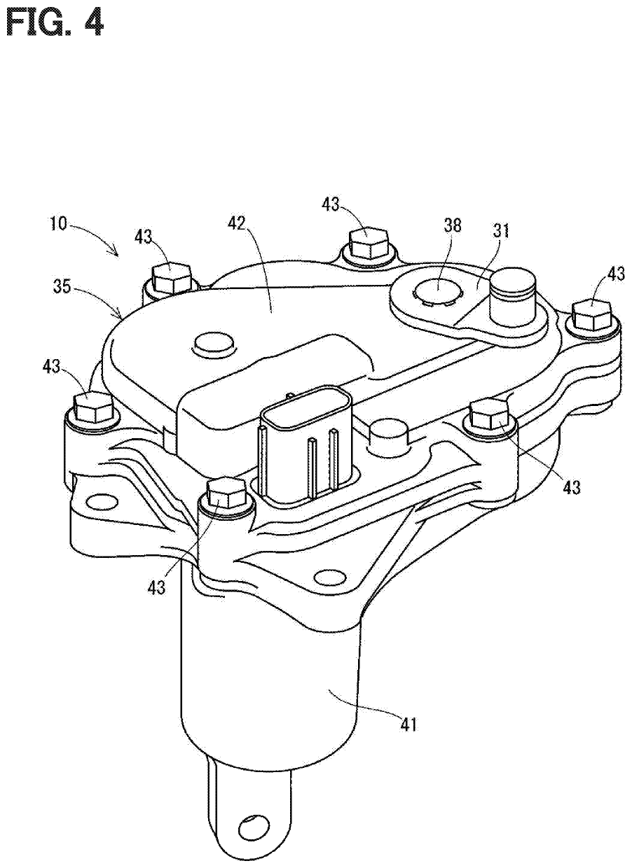

Next, the actuator 10 will be described with reference to FIGS. 4 to 8. The actuator 10 includes a housing 35, an electric motor 36, a speed reducer 37, an output shaft 38 and a rotational angle sensor 39. The housing 35 is installed to the intake compressor 15, and the electric motor 36, the speed reducer 37, the output shaft 38 and the rotational angle sensor 39 are installed in the housing 35.

As shown in FIGS. 4 to 6, the housing 35 includes a first housing segment 41 and a second housing segment 42. The second housing segment 42 is joined to the first housing segment 41 by fastening members 43. The first housing segment 41 and the second housing segment 42 cooperate together to form a receiving space 44 therein. The first housing segment 41 and the second housing segment 42 are made of a metal material, such as an aluminum alloy, and are formed by die casting.

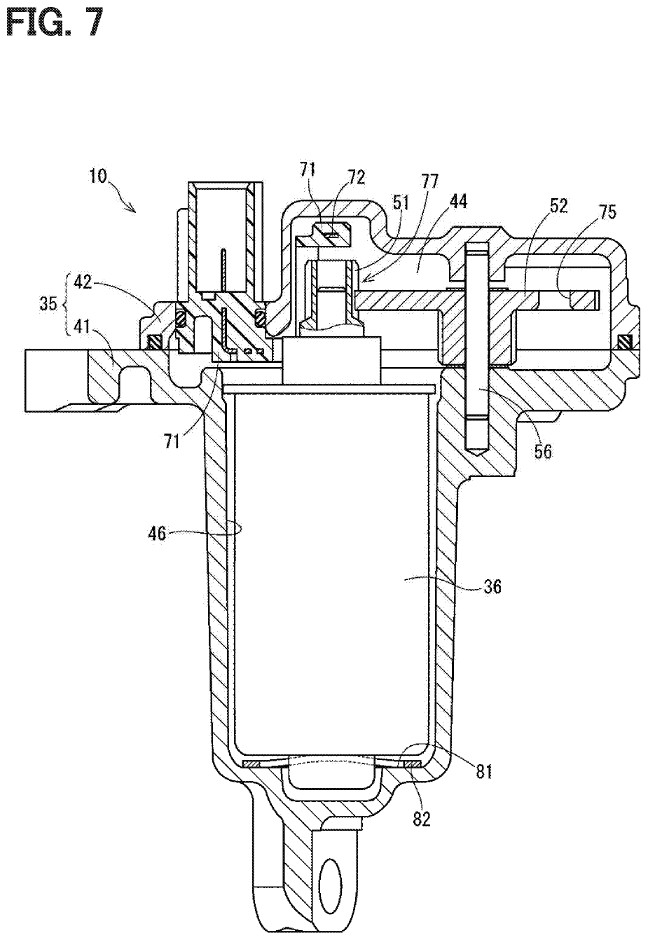

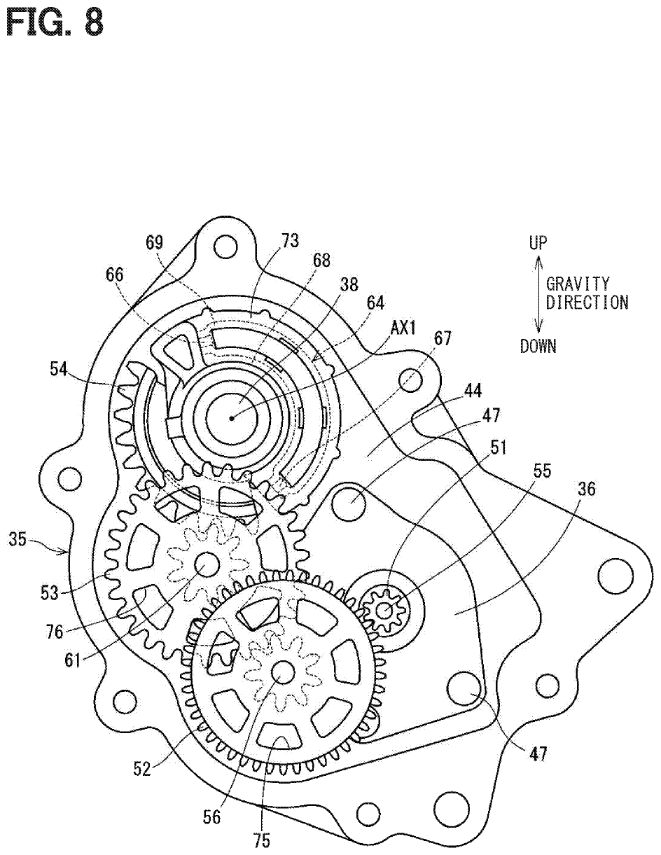

As shown in FIGS. 7 and 8, the electric motor 36 is received in the housing 35 and is fixed to the housing 35 with screws 47. The electric motor 36 may be any type of electric motor, such as a known DC motor, a known stepping motor or the like.

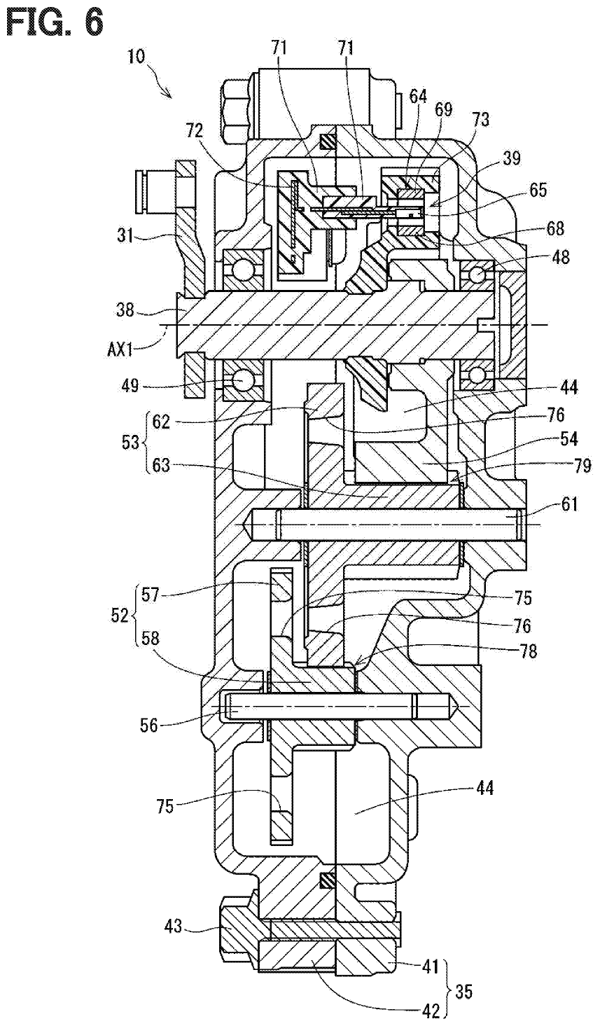

As shown in FIG. 6, the output shaft 38 is rotatably supported by a bearing 48, which is installed to the first housing segment 41, and a bearing 49, which is installed to the second housing segment 42. One end portion of the output shaft 38 outwardly projects from the housing 35. The actuator lever 31 is fixed to the output shaft 38 at the outside of the housing 35.

As shown in FIGS. 6 to 8, the speed reducer 37 is a parallel shaft speed reducer that reduces the speed of the rotation outputted from the electric motor 36 and transmits the rotation of the reduced speed to the output shaft 38. The speed reducer 37 includes a pinion gear 51, a first intermediate gear 52, a second intermediate gear 53 and a final gear 54. The pinion gear 51 is fixed to a motor shaft 55 of the electric motor 36. The first intermediate gear 52 is rotatably supported by a first metal shaft 56 and includes: a first large diameter external gear 57, which is meshed with the pinion gear 51; and a first small diameter external gear 58 that has a diameter smaller than a diameter of the first large diameter external gear 57. The second intermediate gear 53 is rotatably supported by a second metal shaft 61 and includes: a second large diameter external gear 62, which is meshed with the first small diameter external gear 58; and a second small diameter external gear 63 that has a diameter smaller than a diameter of the second large diameter external gear 62. The final gear 54 is fixed to the output shaft 38 and is meshed with the second small diameter external gear 63.

As shown in FIGS. 6 and 8, the rotational angle sensor 39 is a contactless sensor that senses a rotational angle of the output shaft 38, and the rotational angle sensor 39 includes a magnetic circuit device 64 and a sensing device 65. The magnetic circuit device 64 includes magnets (serving as magnetic flux generators) 66, 67 and yokes (serving as magnetic flux conductors) 68, 69. The magnets 66, 67 and the yokes 68, 69 form a closed magnetic circuit that is shaped in an arcuate form in a view taken in an axial direction of the output shaft 38. The magnetic circuit device 64 is held by a magnetic circuit holder member 73 made of a non-magnetic material and is rotated integrally with the output shaft 38. The sensing device 65 is, for example, a Hall IC and is placed at an inside of the closed magnetic circuit of the magnetic circuit device 64. The sensing device 65 is insert molded in a wiring holder member 71 made of a dielectric material and is fixed to the housing 35. The basic applications and functions of the magnetic circuit device 64 and the sensing device 65 are the same as those disclosed in JP2014-126548A (corresponding to US2014/0184204A, the disclosure of which is incorporated herein by reference in its entirety). The rotational angle of the output shaft 38, which is sensed with the rotational angle sensor 39, is outputted to the ECU 34 (see FIG. 1).

### (Housing and Speed Reducer)

Next, the housing 35 and the speed reducer 37 will be described. As shown in FIGS. 6 to 8, the speed reducer 37 includes three pairs of metal gears. Specifically, these pairs of metal gears include: a first pair of gears, which include the pinion gear 51 and the first large diameter external gear 57; a second pair of gears, which include the first small diameter external gear 58 and the second large diameter external gear 62; and a third pair of gears, which include the second small diameter external gear 63 and the final gear 54. These metal gears are made of iron-based sintered metal, and grease is applied to gear tooth surfaces of these metal gears. The iron-based sintered metal is generally a magnetic material. Hereinafter, the pinion gear 51, the first large diameter external gear 57, the first small diameter external gear 58, the second large diameter external gear 62, the second small diameter external gear 63 and the final gear 54 will be simply referred to as the metal gears unless otherwise specified.

The housing 35 receives the metal gears and the magnetic circuit device 64 in the common receiving space 44 of the housing 35. Specifically, the metal gears and the magnetic circuit device 64 are received in the common space while there is no partition between the metal gears and the magnetic circuit device 64. The first large diameter external gear 57 has a plurality of through-holes 75, which penetrate through the first large diameter external gear 57 in the axial direction. The through-holes 75 are arranged one after the other in the circumferential direction. The second large diameter external gear 62 has a plurality of through-holes 76, which penetrate through the second large diameter external gear 62 in the axial direction. The through-holes 76 are arranged one after the other in the circumferential direction.

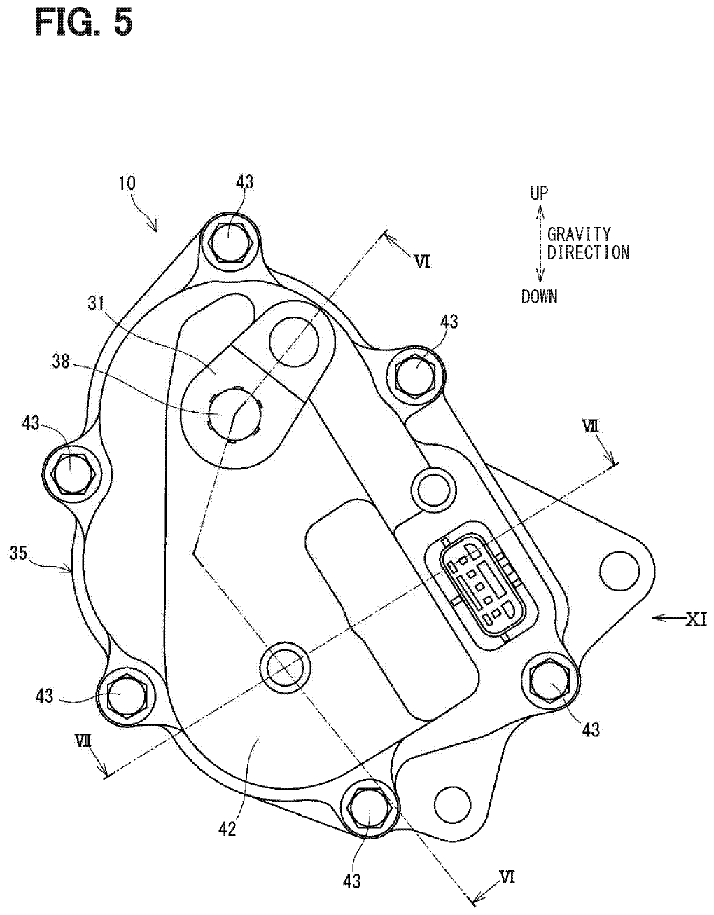

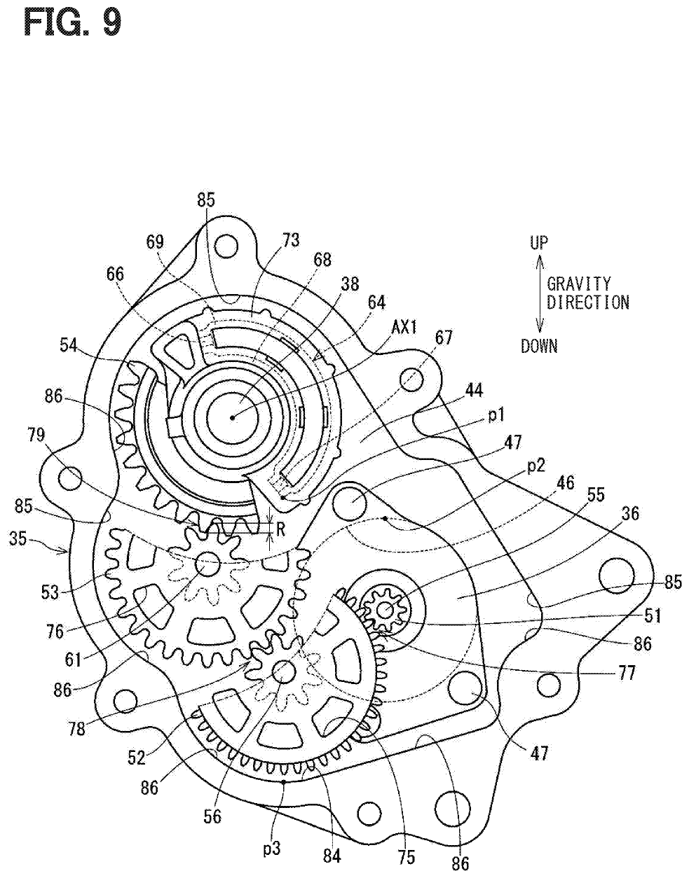

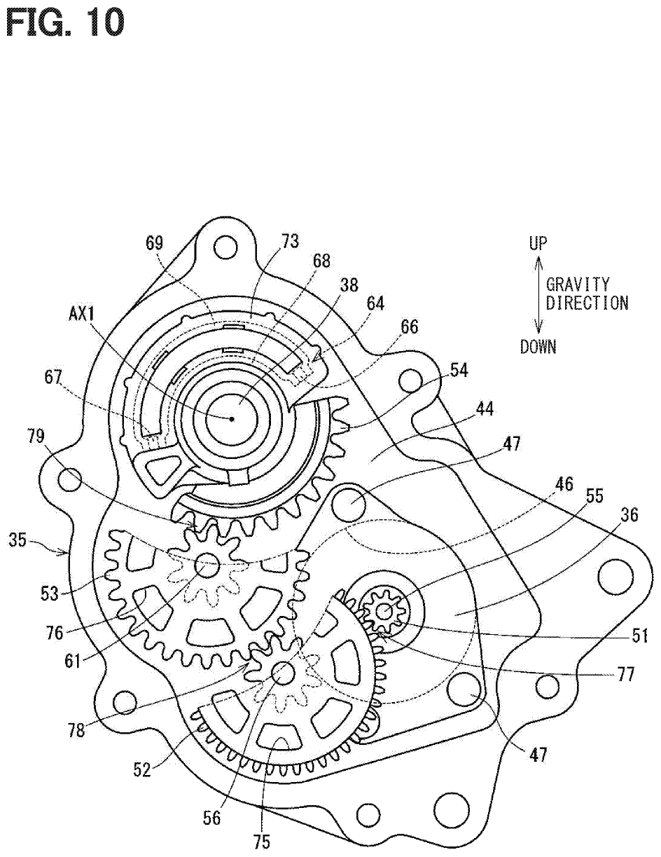

FIGS. 5, 9 and 10 indicate the actuator 10 in a state where the actuator 10 is installed to the engine 11. The output shaft 38 is operable, i.e., rotatable throughout a range that is from an operational position of the output shaft 38 shown in FIG. 9 to another operational position of the output shaft 38 shown in FIG. 10. This operable range of the output shaft 38 corresponds to an operational range of the wastegate valve 26, which is from a full closing position of the wastegate valve 26 to a full opening position of the wastegate valve 26, and this operable range of the output shaft 38 is narrower than a rotation limit range of the output shaft 38, which is limited by a stopper (not shown). Within the operable range of the output shaft 38, the magnetic circuit device 64 is placed to a lowest position thereof in the gravity direction in the state shown in FIG. 9. At this time, a lowest point of the magnetic circuit device 64, which is lowest in the gravity direction, is defined as a magnetic circuit lowest point p1. As shown in FIG. 9, in the installed state of the actuator 10 where the actuator is installed to the engine 11, each pair of the metal gears are meshed with each other at a meshing portion 77, 78 or 79, and these meshing portions 77, 78, 79 of the metal gears are located on the lower side of the magnetic circuit lowest point p1 in the gravity direction. The meshing portion 79 is positioned at an uppermost location in the gravity direction among the meshing portions 77, 78, 79. A range of the meshing portion 79 in the gravity direction is defined as an uppermost meshing region R. In the installed state of the actuator 10 where the actuator is installed to the engine 11, the magnetic circuit lowest point p1 is placed at a location that is higher than the uppermost meshing region R.

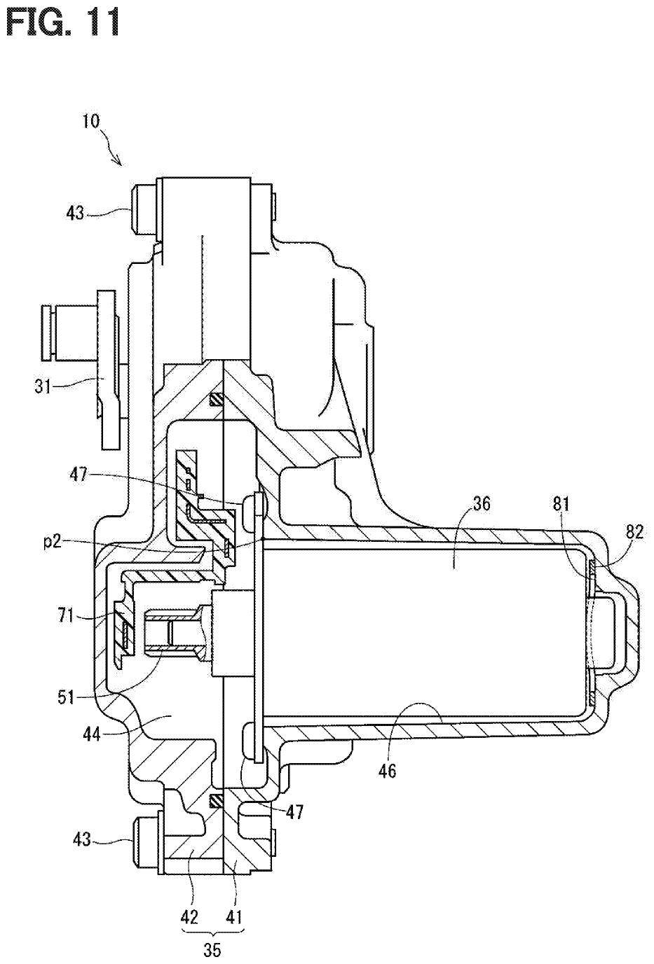

As shown in FIG. 11, the electric motor 36 is inserted into a motor insertion hole 46 that is formed at an inside of the first housing segment 41. Furthermore, the electric motor 36 is fixed to the first housing segment 41 with screws 47. A wave washer 82 is installed between a bottom surface 81 of the motor insertion hole 46 and the electric motor 36. The bottom surface 81 of the motor insertion hole 46 and the electric motor 36 contact the wave washer 82. The wave washer 82 is an urging member that supports the electric motor 36 while allowing relative movement between the electric motor 36 and the first housing segment 41. In the installed state of the actuator 10 where the actuator is installed to the engine 11, a highest point of the motor insertion hole 46, which is highest in the gravity direction, is defined as an insertion hole highest point p2. The insertion hole highest point p2 is located on a lower side of the magnetic circuit lowest point p1 in the gravity direction.

As shown in FIG. 9, in the installed state of the actuator 10 where the actuator 10 is installed to the engine 11, a lowest point of an inner wall surface 84 of the housing 35, which is lowest in the gravity direction in a view taken in the axial direction of the output shaft 38, is defined as an inner wall lowest point p3. FIG. 9 shows a cross section of the housing 35, which is perpendicular to the axial direction of the output shaft 38 and passes through the inner wall lowest point p3. In this cross section, the inner wall surface 84 includes: downward-facing surfaces 85, each of which is a surface that faces downward in the gravity direction; and upward-facing surfaces 86, each of which is a surface that faces upward in the gravity direction. The downward-facing surface 85 faces downward in the gravity direction, so that foreign objects adhered to the downward-facing surface 85 fall downward away from the downward-facing surface 85 by the gravity. The upward-facing surface 86 is tilted toward the inner wall lowest point p3. Specifically, the inner wall surface 84 does not form a concave at the other location of the inner wall surface 84, which is other than the inner wall lowest point p3, so that accumulation of the wear particles along the inner wall surface 84 in the vertical direction is limited.

### (Advantages)

As described above, the actuator 10 includes the electric motor 36, the output shaft 38, the speed reducer 37, the rotational angle sensor 39 and the housing 35. The speed reducer 37 includes the three pairs of metal gears. The housing 35 receives the metal gears and the magnetic circuit device 64 in the common receiving space 44. In an installed state of the actuator 10 where the actuator 10 is installed to the engine 11, the meshing portions 77, 78, 79 of the metal gears are located on a lower side of the magnetic circuit lowest point p1 in the gravity direction.

By using the metal gears in the speed reducer 37, the required strength of the speed reducer 37 against the relatively large load caused by the pulsation of the exhaust gas can be guaranteed. In this way, the damage to the gears of the speed reducer 37 is limited. Furthermore, since the meshing portions 77, 78, 79 of the metal gears are located on the lower side of the magnetic circuit lowest point p1 in the gravity direction, the wear particles, which are the magnetic material and are generated at the metal gears, fall downward by the gravity in the direction away from the magnetic circuit device 64. That is, adhesion of the wear particles to the magnetic circuit device 64 at the time of falling down of the magnetic wear particles is limited. Therefore, it is possible to limit the deterioration in the rotational angle sensing accuracy caused by the adhesion of the wear particles to the magnetic circuit device 64.

Furthermore, in the first embodiment, the grease is applied to the gear tooth surfaces of the metal gears. Thereby, the wear particles, which are generated at the metal gears, are captured by the grease. Therefore, spattering of the wear particles is limited to limit adhesion of the wear particles to the magnetic circuit device 64, so that the deterioration in the rotational angle sensing accuracy can be limited.

Furthermore, in the first embodiment, the housing 35 includes the motor insertion hole 46, into which the electric motor 36 is inserted. The motor insertion hole 46 has a contact portion, which contacts the wave washer 82, and the electric motor 36 has a contact portion, which contacts the wave washer 82. In the installed state of the actuator 10 where the actuator 10 is installed to the engine 11, the insertion hole highest point p2 is located on the lower side of the magnetic circuit lowest point p1 in the gravity direction. In this way, when the wear particles, which are generated at a sliding portion between the wave washer 82 and the housing 35 and a sliding portion between the wave washer 82 and the electric motor 36, are expelled from the motor insertion hole 46, the wear particles fall downward away from the magnetic circuit device 64 by the gravity. Therefore, it is possible to limit the deterioration in the rotational angle sensing accuracy.

Furthermore, according to the first embodiment, in the installed state of the actuator 10 where the actuator is installed to the engine 11, in the cross section of the housing 35, which is perpendicular to the axial direction of the output shaft 38 and passes through the inner wall lowest point p3, the upward-facing surface 86 of the inner wall surface 84, which faces upward in the gravity direction, is tilted toward the inner wall lowest point p3. In this way, the generated wear particles are guided to a lowest portion of the receiving space 44 along the inner wall surface 84. Therefore, the spattering of the accumulated wear particles is limited to limit adhesion of the wear particles to the magnetic circuit device 64, so that the deterioration in the rotational angle sensing accuracy can be limited.

Furthermore, according to the first embodiment, each of the intermediate gears 52, 53 includes: the small diameter external gear 58, 63, which is the metal gear; and the large diameter external gear 57, 62, which is the metal gear. The diameter of the large diameter external gear 57, 62 is larger than the diameter of the small diameter external gear 58, 63. Furthermore, the large diameter external gear 57, 62 has the through-holes 75, 76, which extend through the large diameter external gear 57, 62 in the axial direction. Therefore, the wear particles, which are generated at the small diameter external gear 58, 63, can be expelled through the through-holes 75, 76.

### Second Embodiment

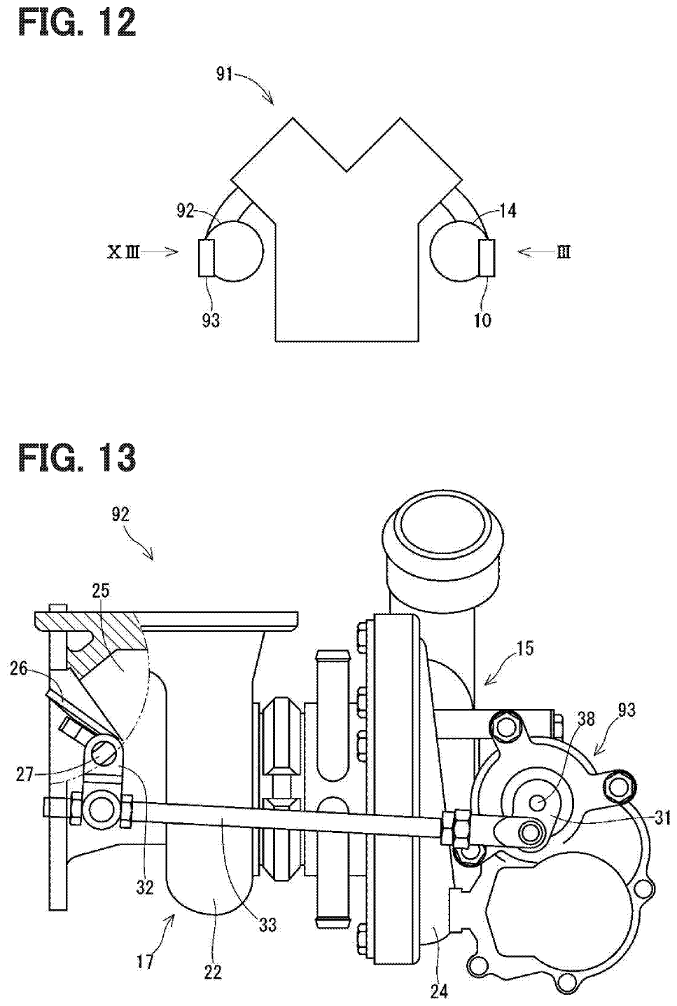

In a second embodiment, as shown in FIG. 12, an internal combustion engine 91 is a V-type engine, and the supercharger 14 is installed to one of engine blocks, and a supercharger 92 is installed to the other one of the engine blocks. With respect to FIGS. 12 and 13, the shape of the supercharger 92 is symmetric to the shape of the supercharger 14 about the left-to-right center in FIG. 12. Similarly, the shape of the actuator 93, which is installed to the supercharger 92, is symmetric to the shape of the actuator 10 about the left-to-right center in FIG. 12. The rest of the configuration of the actuator 93, which is other than the shape described above, is the same as that of the actuator 10. For instance, each meshing portion between the corresponding metal gears, is also located on the lower side of the magnetic circuit lowest point in the gravity direction even in the actuator 93. Therefore, the actuator 93 can achieve the same advantages as those of the actuator 10.

### Third Embodiment

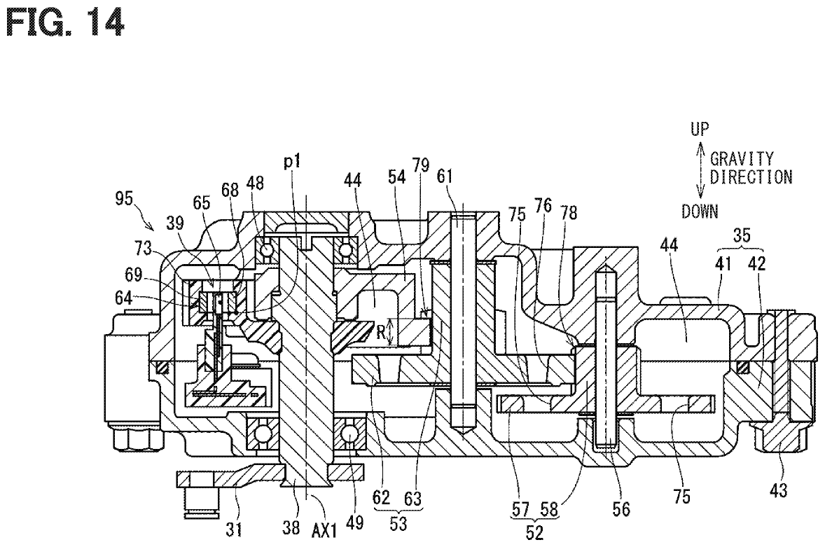

In a third embodiment, an actuator 95 is installed in a manner shown in FIG. 14. Specifically, the actuator 95 is installed such that the axial direction of the output shaft 38 generally coincides with the gravity direction. Even in the actuator 95, similar to the actuator 10 of the first embodiment, each meshing portion 78, 79 between the corresponding metal gears is located on the lower side of the magnetic circuit lowest point p1 in the gravity direction. This is also the same in the meshing portion between the first large diameter external gear 57 and the pinion gear (not shown). In the actuator 95, similar to the actuator 10, the damage of the gears of the speed reducer 37 can be limited, and the deterioration in the rotational angle sensing accuracy caused by the adhesion of the wear particles to the magnetic circuit device 64 can be limited.

### OTHER EMBODIMENTS

In the first and second embodiments, the actuator is installed to the engine such that the axial direction of the output shaft generally coincides with the horizontal direction. In the third embodiment, the actuator is installed to the engine such that the axial direction of the output shaft generally coincides with the gravity direction. In contrast, in another embodiment, the actuator may be installed to the engine such that the axial direction of the output shaft is tilted relative to the horizontal direction and the gravity direction. Even in this case, as long as each meshing portion between the corresponding metal gears is located on the lower side of the magnetic circuit lowest point in the gravity direction in the speed reducer, the advantages, which are similar to those of the first, second and/or third embodiment, can be achieved.

In another embodiment, the material of the gears of the speed reducer should not be limited to the iron-based sintered metal, and the gears of the speed reducer may be made of another type of metal. For instance, in a case where the austenitic stainless steel is used as the material of the gears, the non-magnetized material may be magnetized due to application of strain to the non-magnetized material. In such a case, the magnetic wear particles are generated. Even in such a case, as long as each meshing portion between the corresponding metal gears of the speed reducer is located on the lower side of the magnetic circuit lowest point in the gravity direction, it is possible to limit the deterioration in the sensing accuracy caused by the adhesion of the magnetic wear particles to the magnetic circuit.

In another embodiment, the grease may not be applied to the gear tooth surfaces of the speed reducer. Furthermore, the large diameter external gear of each intermediate gear may not have the through-holes, which extend through the large diameter external gear in the axial direction. Also, the electric motor may be installed such that the electric motor directly contacts the inner wall surface of the motor insertion hole.

The present disclosure has been described based on the embodiments. However, the present disclosure should not be limited to the above embodiments and the structure described therein. The present disclosure encompasses various modifications and equivalents. Also, various combinations and forms, as well as other combinations and forms including only one element, more or less, are within the scope and spirit of the present disclosure.

What is claimed is:

1. An actuator configured to drive a boost pressure control valve of a supercharger of an internal combustion engine, the actuator comprising:
an electric motor;
an output shaft;
a speed reducer that includes at least one pair of metal gears, which are meshed with each other, wherein the speed reducer is configured to reduce a speed of rotation outputted from the electric motor and transmit the rotation of the reduced speed to the output shaft;
a rotational angle sensor that includes a magnetic circuit device and a sensing device and is configured to sense a rotational angle of the output shaft; and
a housing that receives the electric motor and the speed reducer and supports the output shaft, wherein:
the housing includes a motor insertion hole, into which the electric motor is inserted;
the motor insertion hole has an inner wall surface that contacts the electric motor or a support member, which supports the electric motor;
the at least one pair of metal gears are made of a magnetic material;
the housing receives the at least one pair of metal gears and the magnetic circuit device in a common space;
in an installed state of the actuator where the actuator is installed to the internal combustion engine, a lowest point of the magnetic circuit device, which is lowest in a gravity direction within an operable range of the output shaft, is defined as a magnetic circuit lowest point, and a highest point of the motor insertion hole, which is highest in the gravity direction, is defined as an insertion hole highest point;
the insertion hole highest point is located on a lower side of the magnetic circuit lowest point in the gravity direction; and
a meshing portion of the at least one pair of metal gears and all of metal contact portions including a contact portion between the electric motor and the support member are located on a lower side of the magnetic circuit lowest point in the gravity direction.

2. The actuator according to claim 1, wherein grease is applied to gear tooth surfaces of the at least one pair of metal gears.

3. The actuator according to claim 1, wherein:
in the installed state of the actuator where the actuator is installed to the internal combustion engine, a lowest point of an inner wall surface of the housing, which is lowest in the gravity direction in a view taken in an axial direction of the output shaft, is defined as an inner wall lowest point; and
in a cross section of the housing, which is perpendicular to the axial direction of the output shaft and passes through the inner wall lowest point, an upward-facing surface of the inner wall surface, which faces upward in the gravity direction, is tilted toward the inner wall lowest point.

4. The actuator according to claim 1, wherein:
the speed reducer includes:
a final gear that is one gear among the at least one pair of metal gears and is fixed to the output shaft;
a pinion gear that is another gear among the at least one pair of metal gears and is fixed to a motor shaft of the electric motor; and
at least one intermediate gear that is located between the final gear and the pinion gear;
the at least one intermediate gear includes:
a small diameter external gear, which is another gear among the at least one pair of metal gears; and
a large diameter external gear, which is another gear among the at least one pair of metal gears and has a diameter that is larger than a diameter of the small diameter external gear; and
the large diameter external gear has a through-hole that extends through the large diameter external gear in the axial direction.
